(19) United States
(12) Patent Application Publication
(10) Pub. No.: US 2025/0298511 A1
(43) Pub. Date: Sep. 25, 2025

(54) MEMORY STATUS BASED TRAFFIC ROUTING ON HETEROGENEOUS MEMORY SUBSYSTEM

(71) Applicant: Tenstorrent USA, Inc., Austin, TX (US)

(72) Inventors: Wei Shu, Santa Clara, CA (US); Yasuo Ishii, Palo Alto, CA (US)

(21) Appl. No.: 18/956,020

(22) Filed: Nov. 22, 2024

Related U.S. Application Data
(60) Provisional application No. 63/568,431, filed on Mar. 21, 2024.

(51) Int. Cl. G06F 3/06

(52) U.S. Cl. CPC G06F 3/0611; G06F 3/0653; G06F 3/0659; G06F 3/0685

(57) ABSTRACT

Systems and methods related to memory status based traffic routing on heterogeneous memory subsystem are disclosed herein. A high bandwidth memory (HBM) may act as a cache for a double data rate (DDR) memory. HBM may have a higher access latency than DDR memory in some situations, such as low usage. Access latency for a read request via a DDR memory may increase substantially when the usage exceeds one or more thresholds. Accordingly, the routing of the read requests may be tailored to reduce access latency. For example, the usage of the DDR memory may be monitored. When the usage is below a percentage threshold, the access request may be routed to DDR memory rather than HBM. When the usage is above a percentage threshold, the access request may be routed to HBM or DDR. Routing read requests in this manner may minimize overall latency of read access requests.

### CROSS REFERENCE TO RELATED APPLICATIONS

This application claims the benefit of U.S. Provisional Patent Application No. 63/568,431, filed Mar. 21, 2024, which is incorporated by reference herein in its entirety for all purposes.

### BACKGROUND

Memory controllers play a crucial role in managing and optimizing the performance of heterogeneous memory systems, which integrate diverse memory technologies within a single computing environment. These controllers serve as the bridge between the central processing unit (CPU) and the various types of memory, such as high-bandwidth memory (HBM), dynamic random-access memory (DRAM), non-volatile memory (NVM), and more. The complexity of heterogeneous memory systems arises from the distinct characteristics and access latencies of each memory type. Memory controllers facilitate efficient data movement, allocation, and retrieval across these heterogeneous components, ensuring that the system can leverage the unique strengths of each memory technology. Furthermore, they employ intelligent algorithms and policies to dynamically adapt to workload demands, optimizing data placement and access patterns to enhance overall system performance and energy efficiency. As technology continues to advance, memory controllers will play a pivotal role in unlocking the full potential of heterogeneous memory architectures, providing a scalable and adaptable solution for diverse computing needs.

### SUMMARY

This disclosure relates to systems and methods related to memory traffic routing on a heterogeneous memory subsystem. In specific embodiments, the heterogeneous memory subsystem services a network of computational nodes. Networks of computational nodes include multiple nodes performing operations in parallel, by respective processing cores of the processing nodes. In order to perform these complex computations, the processor or processors of the processing cores are constantly writing and reading large amounts of information into memory within the core, including local cache and main memory.

Some main memory may include heterogeneous memory systems, with multiple types of memory such as a double data rate (DDR) memory and a high bandwidth memory (HBM). As an example, a main memory may include an HBM memory that functions as a cache or buffer for the DDR memory, due to the HBM memory having relatively large bandwidth in comparison with the DDR memory. The DDR memory, which has relatively large storage capacity compared to the HBM memory, can then ingest the information temporarily stored in the HBM based on the DDR memory's bandwidth. HBM memory may have a higher bandwidth than DDR memory while using less power and in a smaller form factor. HBM may also have longer idle access latency than other DRAM memories at bandwidth usages below a certain threshold. An interface of the HBM with a host compute die may be divided into independent channels that may be independent of one another and are not necessarily synchronous to each other.

During a read request to such a heterogeneous memory, status information about the memories may be monitored based on a latency criteria to determine optimal routing of read requests to minimize overall latency of read access requests. As an example, DDR memory may have a range of access latency times under different conditions. One such condition may be the usage of the DDR memory, such that the access latency via the DDR memory increases substantially when the usage exceeds one or more thresholds. Accordingly, rather than always routing read access requests to the heterogeneous memory in the same manner, the system can set up a heterogeneous memory hierarchy. In this way, the routing of the requests may be tailored to achieve optimal (minimum) access latency. For example, the usage of the DDR memory may be monitored, and so long as the usage is below a percentage threshold (and other special conditions are satisfied as described herein), the access request is routed to DDR rather than HBM. The system can monitor usage and access latency in real time, including by sending test access requests to the DDR and HBM, in order to dynamically tune the status information measured (e.g., DDR bandwidth usage, capacity usage) and latency criteria (e.g., one or more percentages of DDR usage). The system can monitor usage by reading DRAM module input queue usage, which is included in the DRAM modules.

In specific embodiments of the invention, a method for routing requests to memory is provided. The method comprises: receiving, at a memory controller, a read request for first data; determining, by the memory controller, a usage of a first memory having the first data; conducting exactly one of: (i) accessing, by the memory controller based on the usage of the first memory satisfying a latency criteria, the first data from the first memory; (ii) accessing, by the memory controller based on the usage of the first memory not satisfying the latency criteria, the first data from a second memory, wherein the second memory is a cache for the first memory; and sending, from the memory controller, the first data to a processing core. In specific embodiments of the invention, the first memory may be a target memory module to provide the first data. If the first data is consistent, fetching the first data from either the first memory or the second memory (e.g., DDR or HBM DRAM modules) may result in the same information.

In specific embodiments of the invention, one or more non-transitory computer-readable media and one or more processors are provided. The one or more non-transitory computer-readable media store instructions, which when executed by the one or more processors cause the one or more processors to conduct a method for routing requests to memory. The method comprises: receiving, at a memory controller, a read request for first data; determining, by the memory controller, a usage of a first memory having the first data; conducting exactly one of: (i) accessing, by the memory controller based on the usage of the first memory satisfying a latency criteria, the first data from the first memory; (ii) accessing, by the memory controller based on the usage of the first memory not satisfying the latency criteria, the first data from a second memory, wherein the second memory is a cache for the first memory; and sending, from the memory controller, the first data to a processing core.

In specific embodiments of the invention, a method is provided. The method comprises: monitoring usage information of a memory; monitoring a read access latency of the memory, the read access latency being associated with the usage information; determining a usage threshold based at least in part on the usage information and the read access latency; determining a usage of a first memory having first data; conducting exactly one of: (i) accessing, based on the usage of the first memory not satisfying the usage threshold, the first data from the first memory; (ii) accessing, based on the usage of the first memory satisfying the usage threshold, the first data from a second memory; and sending the first data to a processing core.

### BRIEF DESCRIPTION OF THE DRAWINGS

The accompanying drawings illustrate various embodiments of systems, methods, and embodiments of various other aspects of the disclosure. A person with ordinary skills in the art will appreciate that the illustrated element boundaries (e.g., boxes, groups of boxes, or other shapes) in the figures represent one example of the boundaries. It may be that in some examples one element may be designed as multiple elements or that multiple elements may be designed as one element. In some examples, an element shown as an internal component of one element may be implemented as an external component in another, and vice versa. Furthermore, elements may not be drawn to scale. Non-limiting and non-exhaustive descriptions are described with reference to the following drawings. The components in the figures are not necessarily to scale, emphasis instead being placed upon illustrating principles.

FIG. 1 provides an example of a network of computational nodes with DDR memory and HBM memory in accordance with specific embodiments of the inventions disclosed herein.

FIG. 2 provides an example of a computational node in accordance with specific embodiments of the inventions disclosed herein.

FIG. 3 provides an example of a core in accordance with specific embodiments of the inventions disclosed herein.

FIG. 4 provides plots of access latency for two example core types in accordance with specific embodiments of the inventions disclosed herein.

FIG. 5 provides an example of a main memory with memory status monitoring in accordance with specific embodiments of the inventions disclosed herein.

FIG. 6 provides examples of steps for performing memory status based traffic routing on a heterogeneous memory subsystem of a processing core in accordance with specific embodiments of the inventions disclosed herein.

FIG. 7 provides plots of access latency for two example core types with a plot corresponding to memory status based traffic routing in accordance with specific embodiments of the inventions disclosed herein.

FIG. 8 provides an example of two access paths for a memory system in accordance with specific embodiments of the inventions disclosed herein.

FIG. 9 provides an example of a flowchart for determining a usage threshold or latency criteria in accordance with specific embodiments of the inventions disclosed herein.

FIG. 10 provides an example of a method for routing requests to memory in accordance with specific embodiments of the inventions disclosed herein.

FIG. 11 provides an example of a method for accessing a first memory even if a latency criteria is not satisfied in accordance with specific embodiments of the inventions disclosed herein.

FIG. 12 provides an example method for accessing a second memory even if a latency criteria is satisfied in accordance with specific embodiments of the inventions disclosed herein.

FIG. 13 provides an example of a method for determining a usage threshold and routing a request to memory based on the usage threshold in accordance with specific embodiments of the inventions disclosed herein.

### DETAILED DESCRIPTION

Reference will now be made in detail to implementations and embodiments of various aspects and variations of systems and methods described herein. Although several exemplary variations of the systems and methods are described herein, other variations of the systems and methods may include aspects of the systems and methods described herein combined in any suitable manner having combinations of all or some of the aspects described.

Different systems and methods for memory status based traffic routing on heterogeneous memory subsystem in accordance with the summary above are described in detail in this disclosure. The methods and systems disclosed in this section are nonlimiting embodiments of the invention, are provided for explanatory purposes only, and should not be used to constrict the full scope of the invention. It is to be understood that the disclosed embodiments may or may not overlap with each other. Thus, part of one embodiment, or specific embodiments thereof, may or may not fall within the ambit of another, or specific embodiments thereof, and vice versa. Different embodiments from different aspects may be combined or practiced separately. Many different combinations and sub-combinations of the representative embodiments shown within the broad framework of this invention, that may be apparent to those skilled in the art but not explicitly shown or described, should not be construed as precluded.

Systems and methods related to memory traffic routing on a heterogeneous memory subsystem are disclosed herein. In specific embodiments, the heterogeneous memory subsystem services a network of computational nodes. Networks of computational nodes include multiple nodes performing operations in parallel, by respective processing cores of the processing nodes. In order to perform these complex computations, the processor or processors of the processing cores are constantly writing and reading large amounts of information into memory within the core, including local cache and main memory. The local cache (e.g., level one (“L1”), level two (“L2”), and/or level three (“L3”) cache) has minimal storage capacity but extremely fast access times, while main memory has one or more memories that provide for larger storage capacity but relatively longer access times, often an order of magnitude greater than the fastest local cache (e.g., L1 or L2).

Some main memory may include heterogeneous memory systems, with multiple types of memory such as a double data rate (“DDR”) memory and a high bandwidth memory (“HBM” or “HBM memory”). As an example, a main memory may include an HBM memory that functions as a cache or buffer for the DDR memory, due to the HBM memory having relatively large bandwidth in comparison with the DDR memory. The DDR memory, which has relatively large storage capacity compared to the HBM memory, can then ingest the information temporarily stored in the HBM based on the DDR memory's bandwidth.

During a read request to such a heterogeneous memory, status information about the memories may be monitored based on a latency criteria to determine optimal routing of read requests to minimize overall latency of read access requests. As an example, DDR memory may have a range of access latency times under different conditions. One such condition may be the usage of the DDR memory, such that the access latency via the DDR memory increases substantially when the usage exceeds one or more thresholds. As used herein, the term usage refers to transient memory bandwidth utilization which can be calculated from memory interface queue usage. Accordingly, rather than always routing read access requests to the heterogeneous memory in the same manner, the routing of the requests may be tailored to achieve optimal (minimum) access latency. For example, the usage of the DDR memory may be monitored, and so long as the usage is below a percentage threshold (and other special conditions are satisfied as described herein), the access request is routed to DDR rather than HBM. The system can monitor usage and access latency in real time, including by sending test access requests to the DDR and HBM, in order to dynamically tune the status information measured (e.g., DDR bandwidth usage, capacity usage) and latency criteria (e.g., one or more percentages of DDR usage).

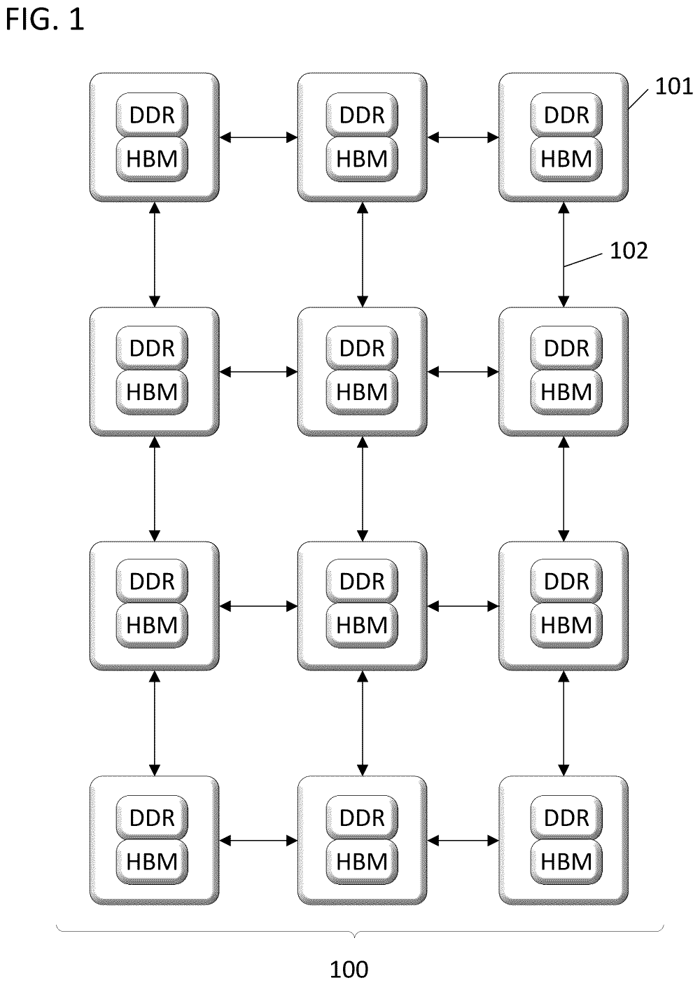

FIG. 1 depicts an exemplary network 100 of computational nodes 101 with DDR memory and HBM memory. In network 100 of FIG. 1, a four-row by three-column configuration of nodes 101 is depicted for illustration purposes in a particular configuration with communication paths 102 between each node 101 and four adjacent nodes 101 (wrapping communication paths, for example, from a right side of a row to a left side of a row or a top of a column to a bottom of a column, and vice versa, not depicted), although it will be understood that the present disclosure applies to any suitable configuration of a network of computational nodes. For example, nodes can be configured in multiple shapes and patterns, with a variety of direct communication paths (e.g., including additional direction communication paths beyond direct communication paths between adjacent nodes).

Regardless of how network 100 of computational nodes 101 is configured, the complex operations and computations performed by network 100 may be dynamically allocated between nodes 101. This allocation may require sequencing of operations, splitting operations and computations between nodes 101, and management of processing and memory capacity within network 100. This management is performed in a manner to optimize usage of the processing cores within each node 101, which may themselves include multiple processors in a variety of combinations and configurations along with internal memory such as caches (e.g., L1, L2, and L3 caches) and main memory (e.g., scratchpad memory, buffer memory, shared memory, on-chip global memory, etc.).

For example, in specific embodiments, network 100 of computational nodes 101 may be serviced by a heterogeneous memory subsystem. The heterogeneous memory subsystem may include multiple types of memory such as DDR memory and HBM memory. Network 100 of computational nodes 101 may include multiple nodes 101 performing operations in parallel (e.g., via respective processing cores of nodes 101). In order to perform complex computations, the processor or processors of the processing cores may write and read large amounts of information into memory within the core, including local cache and main memory. As an example, a main memory may include an HBM memory that functions as a cache or buffer for the DDR memory, due to the HBM memory having relatively large bandwidth in comparison with the DDR memory. The DDR memory, which has relatively large storage capacity compared to the HBM memory, may then ingest the information temporarily stored in the HBM based on the DDR memory's bandwidth.

During a read request to such a heterogeneous memory of node 101, status information about the memories may be monitored based on a latency criteria to determine optimal routing of read requests to minimize overall latency of read access requests. As an example, DDR memory of node 101 may have different access latency times under different conditions. One such condition may be the usage of the DDR memory, such that the access latency via the DDR memory increases substantially when the usage exceeds one or more thresholds. Accordingly, rather than always routing read access requests to the heterogeneous memory of node 101 in the same manner, the routing of the requests may be tailored to achieve optimal (minimum) access latency. For example, the usage of the DDR memory of node 101 may be monitored, and so long as the usage is below a percentage threshold (and other special conditions are satisfied as described herein), the access request is routed to the DDR memory of node 101 rather than to the HBM memory of node 101. By monitoring the usage of the DDR memory of node 101, and routing access requests according to that usage, latency is reduced. HBM and DDR memories of each node 101 are merely examples of heterogeneous memories and a variety of other memory types may be used.

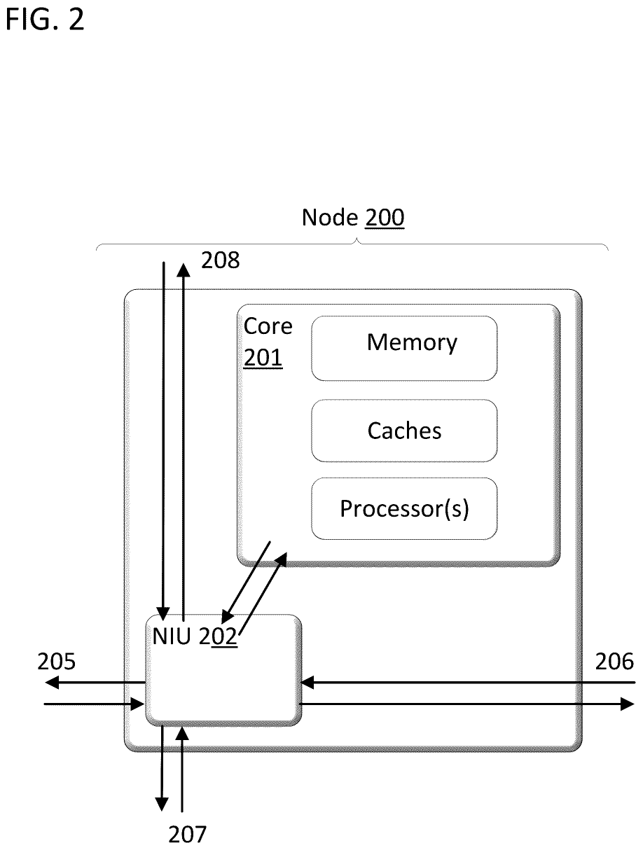

FIG. 2 depicts an exemplary computational node 200. The structure and components of node 200 are simplified for purposes of describing the relevant memory management operations for purposes of the present disclosure. For example, while communications between the node 200 and other nodes are depicted as via communication paths 205, 206, 207, and 208 via a network interface unit (“NIU”) 202, it will be understood that a variety of communication interfaces and components may be utilized to communicate between nodes, for example, in a network-on-chip (“NoC”) architecture. Further, the NIU is depicted as communicating with core 201, but may be a component of the core or may have functionality split with other components. Moreover, while core 201 is depicted with particular components relevant to the present disclosure including processors (e.g., CPUs, GPUs, etc.), local caches, and main memory, it will be understood that a variety of core hardware configurations may be utilized for a node functioning as system cache.

Local cache memory resident on the nodes (e.g., within a core of each node) may be utilized for high-speed storage and access to information that needs to be quickly accessed, that is temporarily stored for use in ongoing operations and computations, or that holds current network management information. Accordingly, local cache memory (e.g., an L1, L2, and/or L3 cache) of node 200 is located within core 201 and is accessible and optimized to provide high speed access to information that that is frequently used by the processor(s). For example, read requests may first be made to the caches with read response times (i.e., access latency) on a scale of 1-2 nanoseconds (ns) for an example L1 cache, 2-4 nanoseconds for an example L2 cache, and 10 nanoseconds for an example L3 cache. Although different cache technologies and configurations may have different absolute values of access latency, the relative access latency of L1 vs. L2 vs. L3, may scale in a similar manner. In specific embodiments, memory cache may be used to configure certain physical memory technology modules as cache to form a typical set-associative structure. Memory cache may be associated with a memory module attached to some certain module (e.g., a core).

The core's main memory may be implemented using a variety of memory technologies and combinations thereof, such as DDR memory (e.g., implemented using synchronous dynamic random-access memory (“SDRAM”) technology), HBM memory, graphics double data rate (“GDDR”) SDRAM, low power double data rate (“LPDDR”) memory, static random-access memory (“SRAM”), embedded dynamic random-access ram (“Embedded DRAM”), and other memory types and combinations thereof. Main memory generally has orders of magnitude more storage than local cache and is used for write storage and read access for most data stored in the node. While the main memory has much greater storage capacity than L1/L2/L3 cache, the access latency of the main memory can be five times greater than, and can be orders of magnitude greater than, the access latency of the L1/L2/L3 cache.

The main memory of node 200 may include heterogeneous memory systems, with multiple types of memory. As an example, the main memory may include an HBM memory that functions as a cache or buffer for DDR memory, due to the HBM memory having relatively large bandwidth in comparison with the DDR memory. The DDR memory, which has relatively large storage capacity compared to the HBM memory, can then ingest the information temporarily stored in the HBM based on the DDR memory's bandwidth.

During a read request to such a heterogeneous memory of node 200, status information about the memories may be monitored based on a latency criteria to determine optimal routing of read requests to minimize overall latency of read access requests. As an example, DDR memory may have a range of different access latency times under different conditions. One such condition may be the usage of the DDR memory, such that the access latency via the DDR memory increases substantially when the usage exceeds one or more thresholds. Accordingly, rather than always routing read access requests to the heterogeneous memory in the same manner, the routing of the requests may be tailored to achieve optimal (minimum) access latency. For example, the usage of the DDR may change how requests are routed. In specific embodiments, the usage of the DDR memory may be monitored, and so long as the DDR usage (e.g., access, capacity, bandwidth, etc.) is below a percentage threshold (and other special conditions are satisfied as described herein), the access request is routed to the DDR memory rather than the HBM memory. Accordingly, so long as the DDR memory usage is above a percentage, the access request may be routed to the HBM memory (e.g., as well as to the DDR memory). Routing access requests in this manner may reduce access latency.

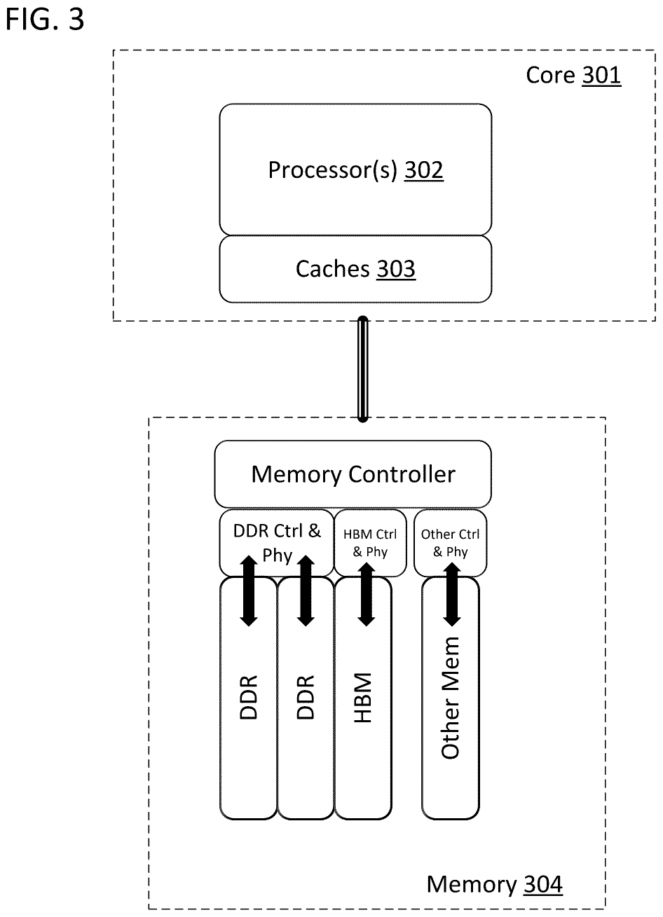

FIG. 3 depicts an exemplary core 301 in accordance with the present disclosure. Processor(s) 302 includes suitable processors and combinations thereof as described herein, while caches 303 includes local caches such as L1 cache, L2 cache, and L3 cache. For read requests where data access times are critical, the processor(s) may first try to access the data from one or more of caches 303, before turning to the memory unit 304, which in turn includes a variety of memories and memory controllers or modules. In the exemplary embodiment depicted in FIG. 3, memory unit 304 includes a memory controller, two DDR memories which in turn interface through a DDR module having control and physical layer functionality for interfacing between the memory controller and the DDR memories, a HBM memory having its own HBM module with control and physical layer functionality for interfacing between the memory controller and the HBM memory, and another memory type having its own module. In this manner a single memory controller can coordinate the write storage and read access functionality of multiple underlying memories by controlling and communicating their respective memory modules.

In the example depicted in FIG. 3, the DDR memory (e.g., two DDR memories) and HBM memory may function collectively based on the memory controller, for example, with the HBM memory functioning as a cache for the DDR memory. In an example implementation, a DDR memory may have access latency in a range of 50 ns-120 ns, a bandwidth in the hundreds of gigabytes per second, and a large (e.g., terabyte range) storage capacity. Compared to the DDR memory, the HBM memory has longer access latency (e.g., in a range of 90-200 ns), a much higher bandwidth (e.g., terabytes per second), and a lower capacity (e.g., in the tens of gigabytes). Based on these complementary bandwidth and storage characteristics, the HBM memory can function as a cache for the DDR memory, quickly ingesting data due to its high bandwidth, while the data is passed to the DDR memory for more persistent storage based on the available bandwidth of the DDR memory. This HBM cache functionality and multi-stage storage with DDR is highly effective for handling large write storage operations and read operations. In specific embodiments, request size (e.g., packet) may be fixed. When bandwidth usage is high (e.g., above the usage threshold), HBM may handle high bandwidth. In this case, accessing HBM may be faster than DDR (or DDR may simply reject the request).

In specific embodiments, HBM memory may be transparent to all software because the HBM memory may be managed by hardware memory controllers. The DDR memory may be visible to software. HBM memory may be organized as a direct-mapped cache. HMB memory or DDR memory may use fake NUMA nodes and/or sub-NUMA clustering. Memory pages may be allocated using a random placement policy. HBM memory may cache frequently accessed data from DDR memory. HBM memory may be integrated into the same package as an SoC, CPU, or GPU (e.g., connected via a silicon interposer). This close proximity may allow fast data transfer rates.

For a low quantity of read accesses, HBM memory may increase read access latency (as the read access latency for HBM memory is generally higher than read access latency for DDR memory). Accordingly, the system may avoid (e.g., skip, refrain from) routing read access to HBM memory while there is a low quantity of read accesses. Instead, the system may route read accesses to the DDR memory. Read access latency for DDR memory may increase with increased DDR memory usage (more reads, etc.). At a DDR certain usage, read access latency of an additional read to DDR memory may be larger than a read access latency to HBM memory. At this usage (and at higher usages), read accesses may be routed to both HBM and DDR memories. Routing read accesses in this way may reduce the latency of the system.

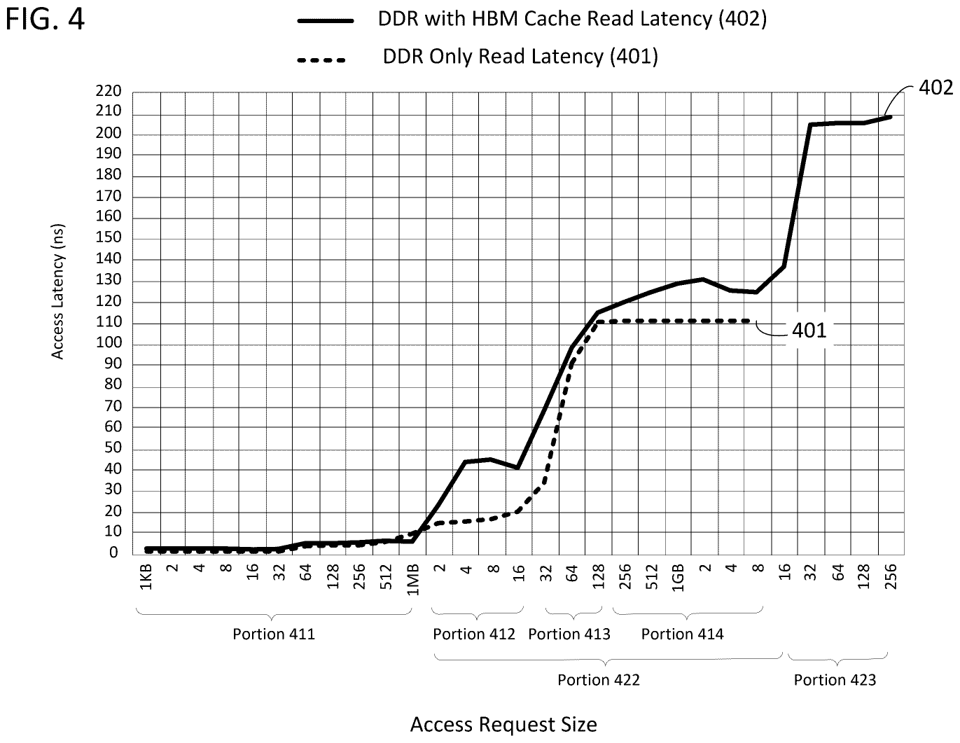

FIG. 4 depicts plots of access latency for two example core types in accordance with an embodiment of the present disclosure. Plot 401 corresponds to a first core that has DDR memory only while plot 402 corresponds to a second core that has DDR memory with an HBM cache. The abscissa of FIG. 4 is read access request size in bytes ranging from 1 kB to 256 GB while the ordinate is the read access latency time in nanoseconds, ranging from 0 to 220 nanoseconds. The plots of FIG. 4 assume that cache and memory management is otherwise being handled properly, for example, such that the data most likely to be accessed is available in a local cache (e.g., L1/L2/L3 cache). In specific embodiments, plot 402 (DDR memory with HBM cache) may extend further along the abscissa than plot 401 (DDR only) due to the system of plot 402 having more memory and more bandwidth and thus more capacity to handle larger access request sizes, although plot 402 generally handles access requests at a higher latency than plot 401.

For a system using HBM as cache (such as plot 402), requests may go to DDR memory if HBM has a cache miss. In this case, the time for the request to reach DDR memory is longer than if the request had been sent to DDR memory directly (e.g., skipping HBM cache). In specific embodiments, even a cache hit in HBM memory may take longer than an access request sent directly to DDR memory, as HBM memory may have a longer access request latency than DDR memory. By routing access requests to DDR memory and avoiding routing access requests to HBM memory until a latency criteria is met, a system may include both the benefit of increased capacity (e.g., similar to plot 402) and decreased latency (e.g., similar to plot 401).

As can be seen from the plot 401 for the first core with DDR only, for read access requests ranging up to about 1 MB of request size (e.g., around portion 411), the read latency time are in a range of 1-2 ns for 1-32 kB (e.g., corresponding to L1 cache) and 6-10 ns for 64 kb to 1 MB read access requests (e.g., corresponding to L2 and/or L3 cache). Between approximately 2 MB to 16 MB (e.g., around portion 412) the read access latency time for plot 401 (with a core of DDR only) begins to increase some as some of read requests require access outside of the local caches (e.g., L1/L2/L3) and instead access the local DDR memory. The access latency of plot 401 quickly increases starting at 32 MB, until at an access request size of 128 MB (e.g., around portion 413). For an access size of approximately 128 MB and more (e.g., to about 8 GB, corresponding to portion 414) the total latency corresponds to the DDR latency plus local cache latency of about 110 ns. After an access size of approximately 128 MB (e.g., around portion 414), plot 401 maintains about the same access latency.

The plot 402 for the second core with a heterogeneous (e.g., HBM and DDR) memory shows read access latency versus access request size for a main memory. As can be seen in plot 402 of FIG. 4, for read access requests up to 1 MB (e.g., around portion 411) the read access latency for core is substantially identical to the read access latency for the core corresponding to plot 401, for example, based on similar local cache (e.g., L1/L2/L3) functionality. Starting at 2 MB, at least some of the read access requests are serviced from the main memory (e.g., DDR+HBM memory), with the requests first serviced by the HBM (e.g., as the cache for the DDR). The access latency increases substantially until virtually all read access requests are serviced by the HBM (e.g., corresponding to portion 422), with an access latency between 110 ns to 140 ns corresponding to the HBM access latency plus local cache latency. Moreover, once the capacity of the HBM memory is exceeded (e.g., at approximately 16 GB in FIG. 4), the read request is then routed to the DDR memory, with the total access latency including the HBM access latency (e.g., approximately 90-200 ns), the DDR access latency (e.g., 50-120 ns), and the local cache access latency (e.g., around portion 423). As can be seen from FIG. 4, the HBM caching for DDR configuration may actually increase access latency, even as it provides bandwidth advantages for large write operations.

As can been seen in FIG. 4, a heterogeneous memory with HMB in addition to DDR may have a higher read access latency for access request sizes greater than around 1 MB, compared to a memory with DDR. This is due to HBM memory generally having a higher read access latency than DDR memory. HBM memory has a higher access latency due to the physical properties of the DRAM module. Accordingly, the system may avoid (e.g., skip, refrain from) routing read access to HBM memory while there is a low quantity of read accesses. In specific embodiments, read access latency for DDR memory may increase with increased DDR memory usage (more reads, etc.). At a DDR certain usage, read access latency of an additional read access to DDR memory may be larger than a read access latency to HBM memory. At this usage (and at higher usages), read accesses may be routed to both HBM and DDR memories. As another example, once the capacity (e.g., bandwidth capacity) of the DDR memory is exceeded, read requests may then be routed to the HBM memory in addition to the DDR memory.

As an example, the system may include avoiding routing read access to HBM memory for read access request sizes below around 32 MB. In this example, a usage associated with a read access request of 32 MB may correspond to the usage threshold and a latency associated with 32 MB of read access requests may correspond to the latency criteria. For read access requests of less than 32 MB, the system may route read accesses to the DDR memory rather than to HBM memory. For read access requests of more than 32 MB, the system may route read accesses to both the DDR memory and the HBM memory. By routing read access directly to DDR and skipping HBM cache based on the size of the access request size, overall access latency may be reduced.

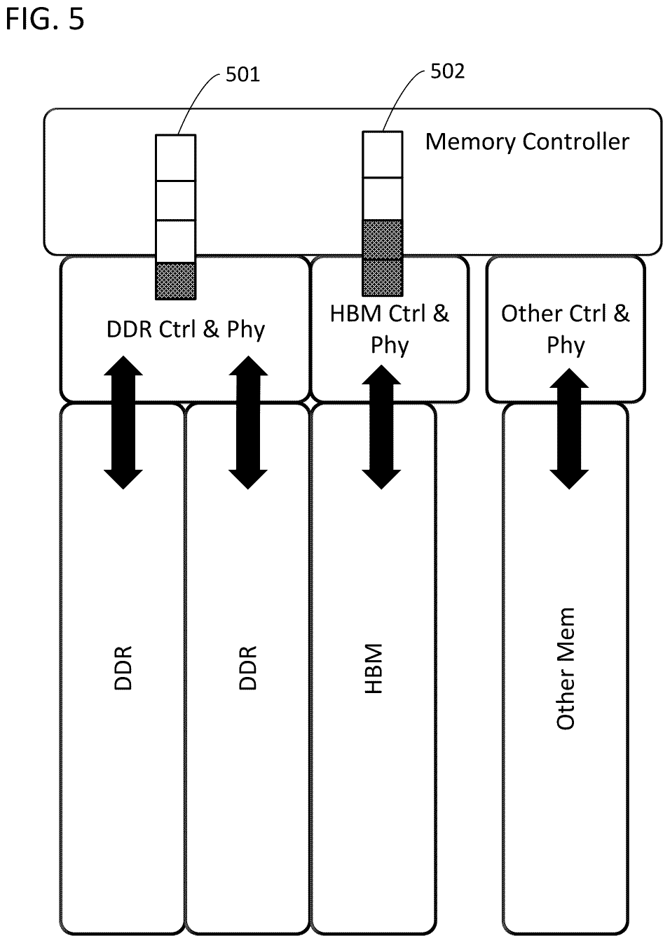

FIG. 5 depicts an exemplary main memory with memory status monitoring in accordance with specific embodiments of the present disclosure. The components of the main memory of FIG. 5 are identical to memory unit 304 of FIG. 3, except that in FIG. 5 status indicators 501 and 502 are depicted. Although depicted in a particular manner in FIG. 5, status indicators 501 and 502 are values, arrays of values, or other data collections that represent an aspect of the status of a memory as described in this FIG. 5. For purposes of FIG. 5, status indicators 501 and 502 are simple “gas gauges” showing the present capacity utilization of the DDR memory (e.g., status indicator 501) and HBM memory (e.g., status indicator 502). The status indicators show the present interface queue utilization of DDR memory and HBM memory. Although a status indicator is not depicted for the other memory, similar operations could be performed with such a memory as are described for DDR and HBM memories as described herein.

Measurement of status information about the memories may be performed by the respective memory module and/or the memory controller based on the ongoing operation of the particular memories. One example of status information is the present usage of the overall capacity (e.g., bandwidth capacity) of the memory, average usage (e.g., average bandwidth usage), or other similar usage statistics. In some instances, the read access latency for the memory may be tracked and associated with usage information, for example, to identify relationships between usage and access latency. A memory's access latency may change (e.g., increase) with memory usage, and in some instances, may increase significantly (e.g., because the access bandwidth has been fully consumed or because of search and access overhead) once particular thresholds are reached. For example, it may be determined that the access latency within a range of access latencies for one or both of the memories (DDR or HBM) increases substantially (e.g., from a low value within the range to an upper portion of the range) at a particular percentage usage, such as 35%, 50%, 60%, or 75%. Such a determination may be performed for typical memory operations and preprogrammed into the memory controller to modify the standard operation of read access requests, such as initially directing read access requests to the DDR memory when the usage of the DDR memory is below a particular threshold associated with relatively fast read access latencies for the DDR memory.

In some embodiments, the thresholds for usage can be dynamic or “self-learned.” During operation, the access latencies associated with routing of particular requests can be monitored during the normal operation of the core, and in some instances, test requests may be made to test latency at appropriate times. In this manner, the thresholds used for selecting between memories (e.g., DDR or HBM) to service read requests can be determined dynamically during device operation, including based on the usage of both memory types.

For a low quantity of read accesses, HBM memory may increase read access latency (as the read access latency for HBM memory is generally higher than read access latency for DDR memory). Accordingly, the main memory of FIG. 5 may avoid (e.g., skip, refrain from) routing read access to HBM memory while there is a low quantity of read accesses. The quantity of read accesses may be measured by status indicators 501 and 502. The main memory of FIG. 5 may route all read access requests to DDR memory until DDR memory satisfies (e.g., meets, exceeds) the threshold usage, as measured by status indicator 501. For example, read access latency for DDR memory may increase with increased DDR memory usage (more reads, etc.), and the threshold usage may correspond to a usage at which a read access latency of DDR memory may be larger than a read access latency of HBM memory. After the threshold is satisfied, the main memory of FIG. 5 may route read access to both HBM memory and DDR memory. The distribution of read access requests may or may not be even across both the DDR memory and the HBM memory and may depend on the latencies of each as well as how these latencies increase with additional read accesses.

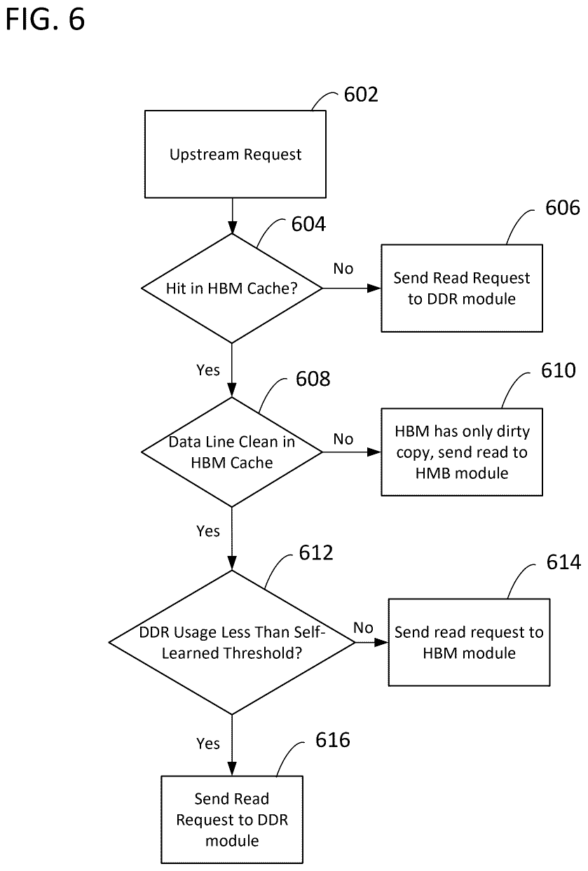

FIG. 6 depicts exemplary steps for performing memory status based traffic routing on a heterogeneous memory subsystem of a processing core in accordance with an embodiment of the present disclosure. Although particular steps are depicted in a particular order in FIG. 6, it will be understood that the order of certain steps may be modified in accordance with the present disclosure and that steps may be added or removed in certain embodiments.

At step 602, an upstream request for read access to certain data may be received. For example, where a data read request from memory cannot be satisfied by the local cache (e.g., L1, L2, or L3 cache), the request propagates such as to a memory controller for further processing and read access via the heterogeneous main memory. In an embodiment, the heterogeneous main memory may have HBM and DDR memory, with the HBM memory functioning as a high-bandwidth write cache or buffer for the DDR memory. Once the upstream request is received, processing may continue to step 604.

At step 604, the memory controller, based on information and processing of the memory controller and/or the HBM memory module, may determine whether there is a hit on the read request within the HBM memory. If there is not a hit in the HBM memory, then rather than attempting to access the data within the HBM memory the request can be serviced directly from the DDR memory, as depicted at step 606 in which the request is sent to the DDR module to access the requested data from DDR memory. If there is a hit in HBM memory, processing may continue to step 608.

At step 608, the memory controller may determine if the data line is clean in the HBM cache. If not, the HBM has the only dirty copy and the read should be sent to the HBM module at step 610. If HBM memory has a dirty copy, then the read request may be sent to HBM for data consistency. In specific embodiments, in a write-back scenario, the HBM cache level may be above the DDR memory level. In this case, the HBM cache may cache a dirty copy. In specific embodiments, the HBM cache may have dirty and clean copies of cache lines. If the HBM data line is clean, processing may continue to step 612.

At step 612 it may be determined whether a latency criteria for the DDR memory is met. The latency criteria may be any suitable criteria based on a status of the DDR memory, and may be dynamic or preprogrammed as described herein. As an example, the status of the DDR memory may be a percentage usage of the DDR memory and a latency criteria may be a threshold percentage. In that example, if the DDR memory interface request queue usage is less than the percentage threshold (or equal to, or considering hysteresis, in some embodiments), the DDR memory may be used to access the data for the read request since the latency to access the DDR memory is expected to be on the low end of its range and less than the HBM latency. In other embodiments, DDR and HBM usage may be compared, such as by determining a “delta” or difference in usage in absolute and/or percentage terms, and utilizing that value as the status value to be compared to the latency criteria.

A memory's read latency may change (e.g., increase) with memory usage, and in some instances, may increase significantly (e.g., because the access bandwidth has been fully consumed or because of search and access overhead) once particular thresholds are reached. For example, it may be determined that the read latency within a range of read latencies for one or both of the memory modules (DDR or HBM) increases substantially (e.g., from a low value within the range to an upper portion of the range) at a particular percentage usage, such as 35%, 50%, 60%, or 75%. The usage threshold of step 612 may be derived from the particular percentage usage. Such a determination may be performed for typical memory operations and preprogrammed into the memory controller and may, in some embodiments, serve as a starting point for a dynamic or “self-learned” threshold.

In some embodiments, the usage threshold of step 612 may be dynamic or “self-learned.” During operation, the read latencies associated with routing of particular read requests can be monitored during the normal operation of the core, and in some instances, test requests may be made to test latency at appropriate times. In this manner, the usage thresholds used for selecting between memory modules (e.g., DDR or HBM) to service read requests can be determined dynamically during device operation and may be based on the usage of both memory types.

Whatever status information and latency criteria are used (e.g., at step 612), if the read access request is to be serviced by the HBM memory, the request may be sent to the HBM memory module for further processing at step 614, and if the read access request is to be serviced by the DDR memory, the request may be sent to the DDR memory module for further processing at step 616. By sending a read request to the HBM module at step 614 or to the DDR module at step 616 (based on DDR usage compared to a threshold at step 612), memory access latency is reduced.

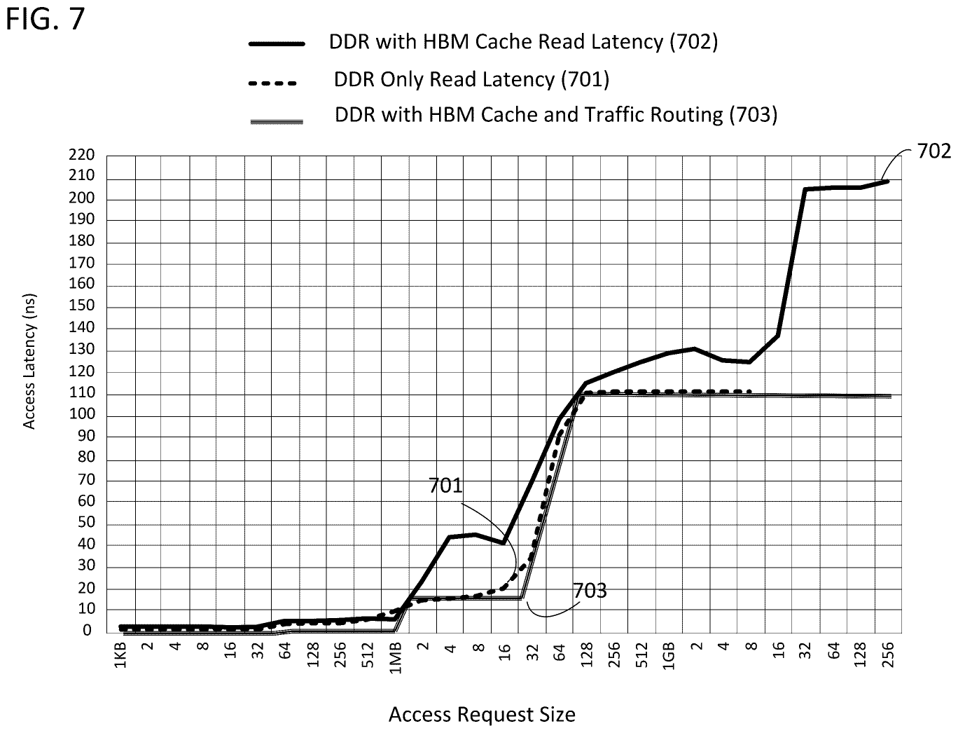

FIG. 7 depicts plots of access latency for two example core types in accordance with an embodiment of the present disclosure, with plot 701 for a first core corresponding to a DDR only memory, the plot 702 for a second core corresponding to a heterogeneous memory with DDR and a HBM cache, and a plot 703 for the second core corresponding to the heterogeneous memory with DDR and a HBM cache but with memory status based traffic routing as described herein. Plot 701 corresponds to plot 401 in FIG. 4, and plot 702 corresponds to plot 402 in FIG. 4. Plot 703 is of the same heterogeneous core as plot 702, but with a memory controller aware of different DRAM module usage and able to perform selective routing of read access requests to DDR or HBM memory. Within the range depicted in FIG. 7, most requests are initially routed to DDR memory in plot 703. Even when routed to HBM memory, the routing is only under specific circumstances where HBM is likely to have similar latency to DDR. Accordingly, the access latency of the heterogeneous core is similar to that of a DDR only core (plot 701), without sacrificing any of the advantages of the HBM functioning as a cache for DDR write requests.

In specific embodiments, plot 702 (DDR memory with HBM cache) and plot 703 (DDR with HBM cache and traffic routing) may extend further along the abscissa than plot 701 (DDR only) due to the system of plot 702 and system of plot 703 having more memory and bandwidth and thus more capacity to handle larger access request sizes. Plot 702 handles access requests at a higher latency than plot 701, while plot 703 has a latency similar to that of plot 701. Plot 703 includes the benefit of low latency of plot 701 while also including the benefit of increased capacity of plot 402. The system of plot 703 may include other benefits of HBM memory (e.g., that the system of plot 702 has) in addition to increased access request size capacity.

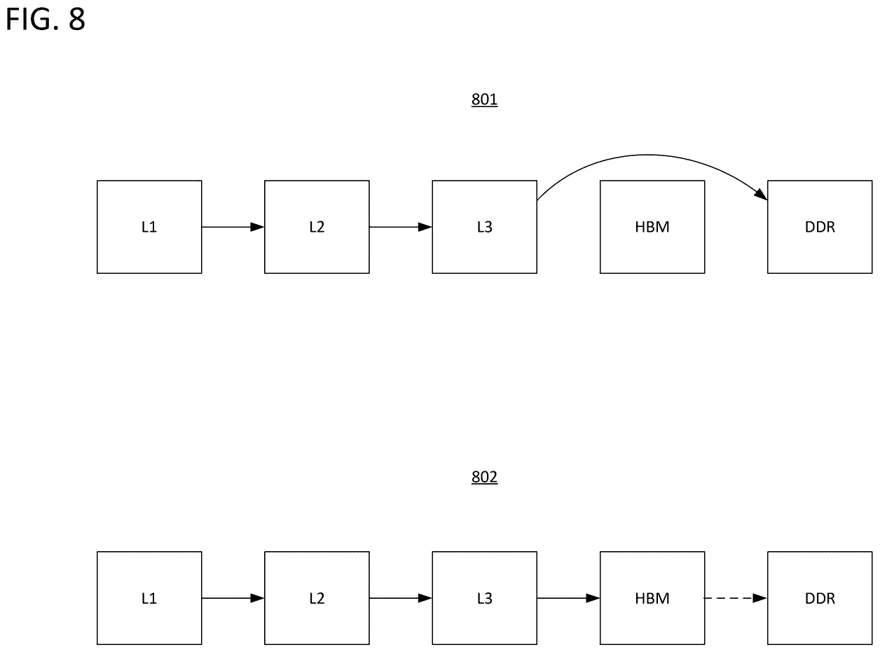

FIG. 8 shows an example of two access paths for a memory system. During a read request, status information about the memories of a main memory may be monitored based on a latency criteria to determine optimal routing of read requests to minimize overall latency of read access requests. Access path 801 shows a read access request when the memory system has low usage (e.g., below a threshold). Access path 802 shows a read access request when the memory system has high usage (e.g., above a threshold). Usage may refer to transient memory bandwidth utilization which can be calculated from memory interface queue usage.

In order to perform complex computations, processor(s) of the system may write and read large amounts of information into memory within a core, including local cache and main memory. The local cache (L1, L2, and L3) may have minimal storage capacity but extremely fast access times, while main memory may have one or more memories (e.g., HBM memory and DDR memory) that provide for larger storage capacity but relatively longer access times. For read requests where data access times are critical, the processor(s) may first try to access the data from caches L1, L2, and L3, before turning to the main memory. The HBM memory may function as a cache or buffer for the DDR memory, due to the HBM memory having relatively large bandwidth in comparison with the DDR memory. The DDR memory, which has relatively large storage capacity compared to the HBM memory, can then ingest the information temporarily stored in the HBM based on the DDR memory's bandwidth. Status information about the DDR and HBM memories may be monitored based on a latency criteria to determine optimal routing of read requests to minimize overall latency of read access requests. Accordingly, rather than always routing read access requests to the heterogeneous memory in the same manner, requests may be routed via access path 801 or access path 802 to achieve minimum access latency.

DDR memory may have a range of access latency times under different conditions. One such condition may be the usage of the DDR memory, such that the access latency via the DDR memory increases substantially when the usage exceeds one or more thresholds. Accordingly, rather than always routing read access requests to the heterogeneous memory in the same manner, the routing of the requests may be adjusted based on memory usage to achieve minimum access latency. For example, the usage of the DDR memory may be monitored, and so long as the usage is below a percentage threshold, the access request is routed to DDR memory via access path 801. If the usage is above the percentage threshold, the access request is routed to HBM memory via access path 802.

In specific embodiments, a read access request may be sent to both a HBM module and a DDR module (e.g., similar to access path 802). For example, the memory controller, based on information and processing of the memory controller and/or the HBM memory module, may determine whether there is a hit on the read request within the HBM memory. If there is not a hit (e.g., a miss) in the HBM memory, then rather than attempting to access the data within the HBM memory the request can be serviced directly from the DDR memory. In this example, the request may be sent to the DDR module to access the requested data from DDR memory.

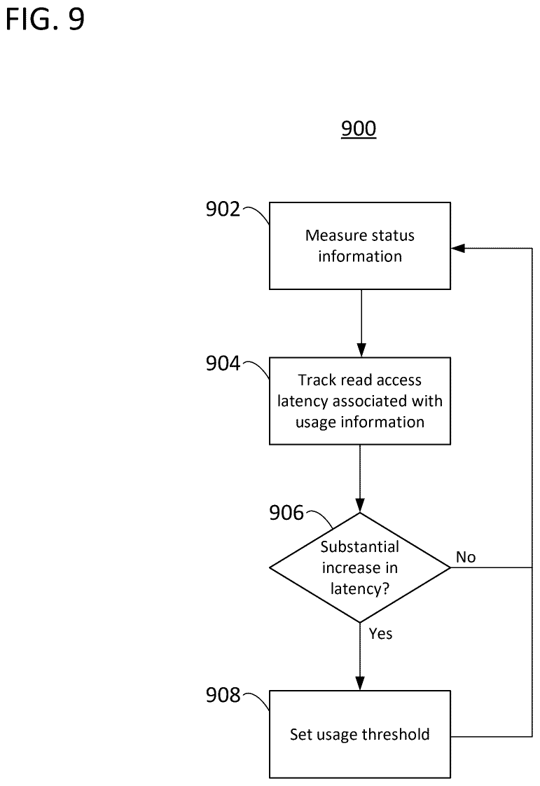

FIG. 9 shows an example flowchart 900 for determining a usage threshold. Flowchart 900 may be performed by a system including one or more processors and one or more memories (e.g., DDR memory and HBM memory). In specific embodiments, the system may include one or more memory controllers and one or more non-transitory computer-readable media. In various specific embodiments, steps of flowchart 900 may be duplicated, omitted, rearranged, or otherwise deviate from the form depicted in FIG. 9.

At step 902, one or more measurements of status information about the memories may be performed. The measurements may be performed by the respective memory module and/or the memory controller based on the ongoing operation of the particular memories. One example of status information is the present usage of the overall bandwidth of the memory, average bandwidth usage, or other similar usage statistics. Usage may refer to transient memory bandwidth utilization which can be calculated from memory interface queue usage. For example, bandwidth usage may be calculated from a number of outstanding requests in the queue multiplied by the request packet size and divided by a fixed time window.

In specific embodiments, at step 904, the read access latency for the memory may be tracked and associated with usage information, for example, to identify relationships between usage and access latency. In specific embodiments, test requests may be made to test latency at appropriate times. A memory's access latency may change (e.g., increase) with memory (e.g., bandwidth) usage, and in some instances, may increase significantly (e.g., because the access bandwidth has been highly consumed) once particular thresholds are reached.

At step 906, whether a substantial increase in latency has occurred may be determined. For example, it may be determined that the access latency within a range of access latencies for one or both of the memories (DDR or HBM) increases substantially (e.g., from a low value within the range to an upper portion of the range) at a particular percentage usage, such as 35%, 50%, 60%, or 75%.

At step 908, the system may set a usage threshold (e.g., the particular percentage usage, such as 35%, 50%, 60%, or 75%) based on the substantial increase in latency determined at step 908. In other words, the usage threshold may be based on observed latencies at different usages. A specific usage percentage may be chosen as the usage threshold based on the latency (e.g. the latency criteria) of the memory (DDR memory, HBM memory, other memory, or a combination thereof). The threshold may be set based on typical memory operations. The threshold may serve to modify the standard operation of read access requests, such as initially directing read access requests to the DDR memory when the usage of the DDR memory is below the usage threshold. The usage threshold (e.g., the DDR memory having a usage below the usage threshold) may be associated with relatively fast read access latencies for the DDR memory.

In specific embodiments, the threshold may be preprogrammed into the memory controller. For example, steps 902 through 906 may be performed on a first system or device and the information gathered may then be used for step 908 to set a usage threshold of a second system or device. In other specific embodiments, steps 902 through 908 may all be performed on a single system or device.

In specific embodiments, a single usage threshold is set. That is, step 908 may be the end of flowchart 900. In other specific embodiments, flowchart 900 loops back to step 902 after performing step 908 and multiple thresholds may be set, or one threshold may be set (e.g., reset) multiple times. In some embodiments, the thresholds for usage can be dynamic or “self-learned.” During operation, the access latencies associated with routing of requests can be monitored during the normal operation of the memories (e.g., associated with the core), and in some instances, test requests may be made to test latency at appropriate times. In this manner, the thresholds used for selecting between memories (e.g., DDR or HBM) to service read requests can be determined dynamically during device operation, including based on the usage of both memory types.

In specific embodiments, the usage threshold may change throughout the life of the system. For example, the DDR memory may have a substantial increase in latency associated with a specific bandwidth percentage usage at one time and may have a substantial increase in latency associated with a different bandwidth percentage usage at another time. The usage threshold may be adjusted to a higher level accordingly. As another example, the system may reevaluate significant increases in latency and adjust the usage threshold accordingly. There may be more than one significant increase in latency and the system may choose which increase to associate with a threshold or may set multiple thresholds.

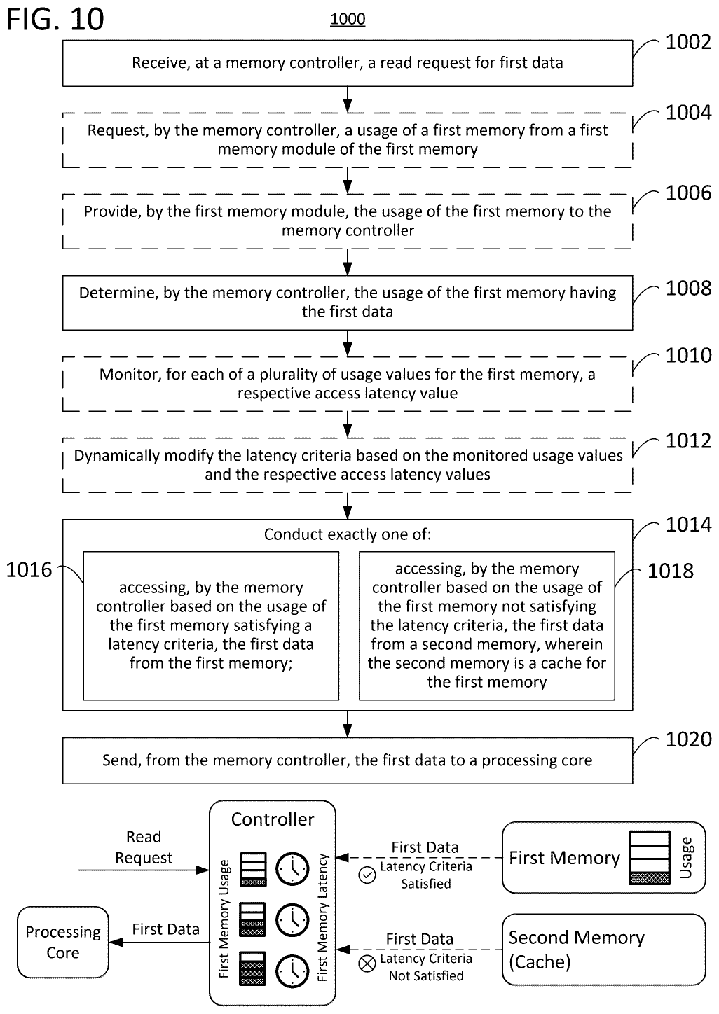

FIG. 10 illustrates an example of method 1000 for routing requests to memory. Method 1000 may be performed by a system including one or more processors and one or more memories (e.g., DDR memory and HBM memory). In specific embodiments, the system may include one or more memory controllers and one or more non-transitory computer-readable media. In various specific embodiments, steps of method 1000 may be duplicated, omitted, rearranged, or otherwise deviate from the form depicted in FIG. 10.

At step 1002 a read request for first data may be received. The read request may be received at a memory controller. In specific embodiments, the read request may be provided to the memory controller based on one or more lower level caches not having the first data. In specific embodiments, the one or more lower level caches may comprise a level one cache, a level two cache, and a level three cache. In specific embodiments, a first access latency of the one or more lower level caches may be at least about an order of magnitude less than a second access latency of the first memory and a third access latency of the second memory.

In specific embodiments, at step 1004, the usage of the first memory may be requested. The usage may be requested by the memory controller and may be requested from a first memory module of the first memory. The first memory may comprise a DDR memory. In specific embodiments, the usage of the first memory may comprise a transient memory bandwidth utilization of the first memory.

In specific embodiments, at step 1006, the usage of the first memory may be provided. The usage may be provided by the first memory module to the memory controller.

At step 1008, a usage of a first memory having the first data may be determined. The usage may be determined by the memory controller.

In specific embodiments, at step 1010, a respective access latency value for each of a plurality of usage values for the first memory may be monitored. In specific embodiments, the latency criteria may be based on the monitored usage values and respective access latency values.

In specific embodiments, at step 1012, the latency criteria may be dynamically modified. The latency criteria may be dynamically modified based on the monitored (e.g., at step 1010) usage values and respective access latency values.

As part of step 1014, exactly one of either step 1016 or step 1018 may be performed. Performing either step 1016 or step 1018 may be based on the usage of the first memory satisfying or not satisfying a latency criteria. In specific embodiments, the latency criteria may comprise a percentage (e.g., a percentage usage of the first memory, a percentage of the transient memory bandwidth utilization of the first memory) being less than a threshold percentage. In specific embodiments, the threshold percentage may be based on an increase in access latency when the usage of the first memory exceeds the threshold percentage.

At step 1016, the first data may be accessed from the first memory. The first data may be accessed by the memory controller. The first data may be accessed based on the usage of the first memory satisfying a latency criteria. In specific embodiments, a first access latency of the first memory may be less than a second access latency of the second memory when the latency criteria is satisfied.

Alternatively to step 1016, at step 1018, the first data may be accessed from the second memory. The first data may be accessed by the memory controller. The first memory may be accessed based on the usage of the first memory not satisfying the latency criteria. The second memory may be a cache for the first memory. In specific embodiments, the first access latency of the first memory may be greater than the second access latency of the second memory at least some of the time when the latency criteria is not satisfied. In specific embodiments, the second memory may comprise HBM memory and a second memory module may interface between the memory controller and the second memory to provide the first data to the memory controller.

At step 1020, the first data may be sent to a processing core. The first data may be sent from the memory controller. Routing access requests as described by method 1000 may result in reduced latency for the requests.

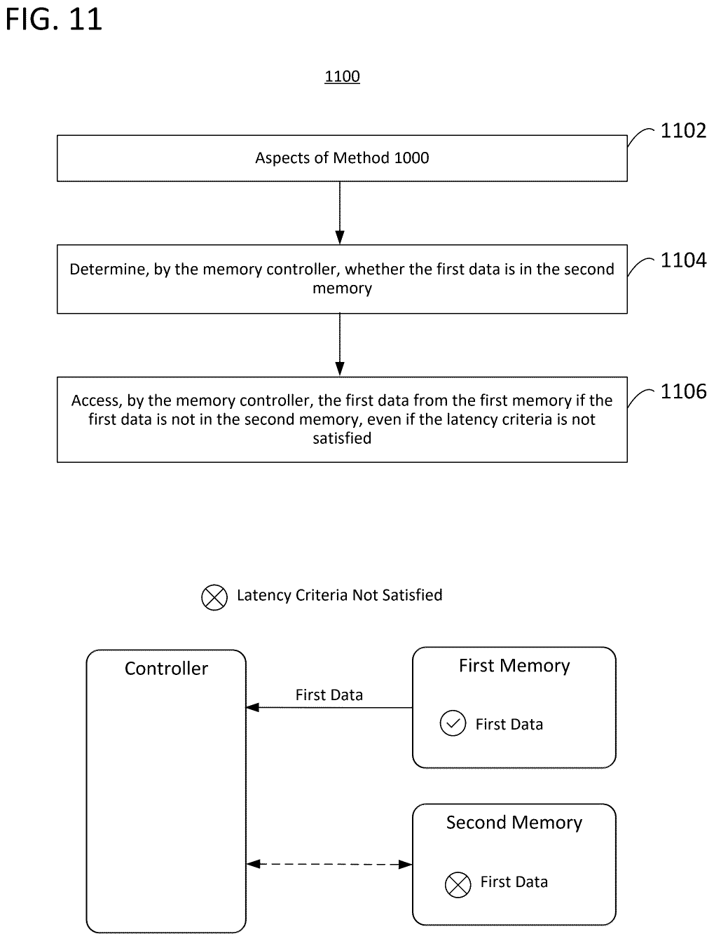

FIG. 11 illustrates an example of method 1100 for accessing a first memory even if a latency criteria is not satisfied. Method 1100 may be performed by a system including one or more processors and one or more memories (e.g., DDR memory and HBM memory). In specific embodiments, the system may include one or more memory controllers and one or more non-transitory computer-readable media. In various specific embodiments, steps of method 1100 may be duplicated, omitted, rearranged, or otherwise deviate from the form depicted in FIG. 11. Method 1100 may be part of, be integrated into, or be a continuation of method 1000.

At step 1102, aspects of method 1000 may be performed. For example, steps 1002 and 1008 may be performed while other steps of method 1000 may be omitted. As another example, steps 1002 through 1014 may be performed.

At step 1104, whether the first data is in the second memory may be determined. Whether the first data is in the second memory may be determined by the memory controller.

At step 1106, the first data may be accessed from the first memory if the first data is not in the second memory, even if the latency criteria is not satisfied. The first data may be accessed by the memory controller.

Aspects of method 1000 may be performed before, during, or after method 1100. For example, step 1020 of sending the first data to a processing core may be performed after step 1106. Routing access requests as described by method 1100 may result in reduced latency for the requests.

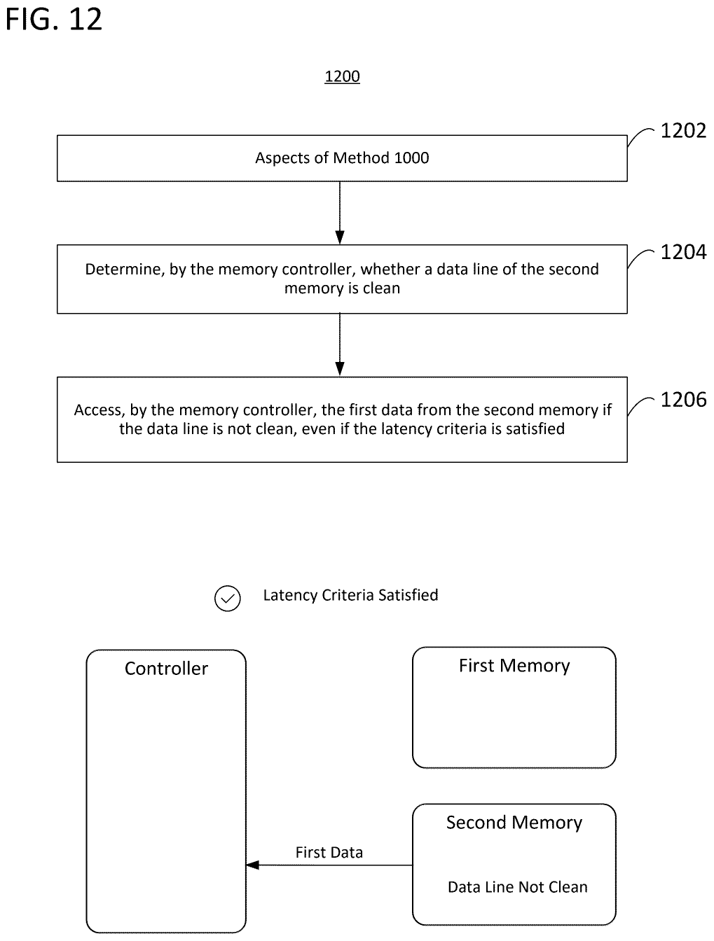

FIG. 12 illustrates an example of method 1200 for accessing a second memory even if a latency criteria is satisfied. Method 1200 may be performed by a system including one or more processors and one or more memories (e.g., DDR memory and HBM memory). In specific embodiments, the system may include one or more memory controllers and one or more non-transitory computer-readable media. In various specific embodiments, steps of method 1200 may be duplicated, omitted, rearranged, or otherwise deviate from the form depicted in FIG. 12. Method 1200 may be part of, be integrated into, or be a continuation of method 1000 and/or method 1100.

At step 1202, aspects of method 1000 may be performed. For example, steps 1002 and 1008 may be performed while other steps of method 1000 may be omitted. As another example, steps 1002 through 1014 may be performed. In specific embodiments, aspects of method 1100 may also be performed.

At step 1204, whether a data line of the second memory is clean may be determined. Whether the data line of the second memory is clean may be determined by the memory controller.

At step 1206, the first data from the second memory may be accessed if the data line is not clean, even if the latency criteria is satisfied. The first data may be accessed by the memory controller.

In specific embodiments, to make memory consistent, a system may adopt a write-through method for a write to memory (e.g., a write request). For example, HBM and DDR memory may be written to at the same time. For each write request carrying dirty (e.g., modified) data, the HBM cache may perform a tag check to see if the data is already cached. If there is a cache hit, then the data may be written to HBM. Meanwhile, the data may also be written to DDR. In this way, both memories stay in sync. In these embodiments, a future read request may be fulfilled by either HBM or DDR memory, as both memories are consistent.

Aspects of method 1000 may be performed before, during, or after method 1200. For example, step 1020 of sending the first data to a processing core may be performed after step 1206. Routing access requests as described by method 1200 may result in reduced latency for the requests.

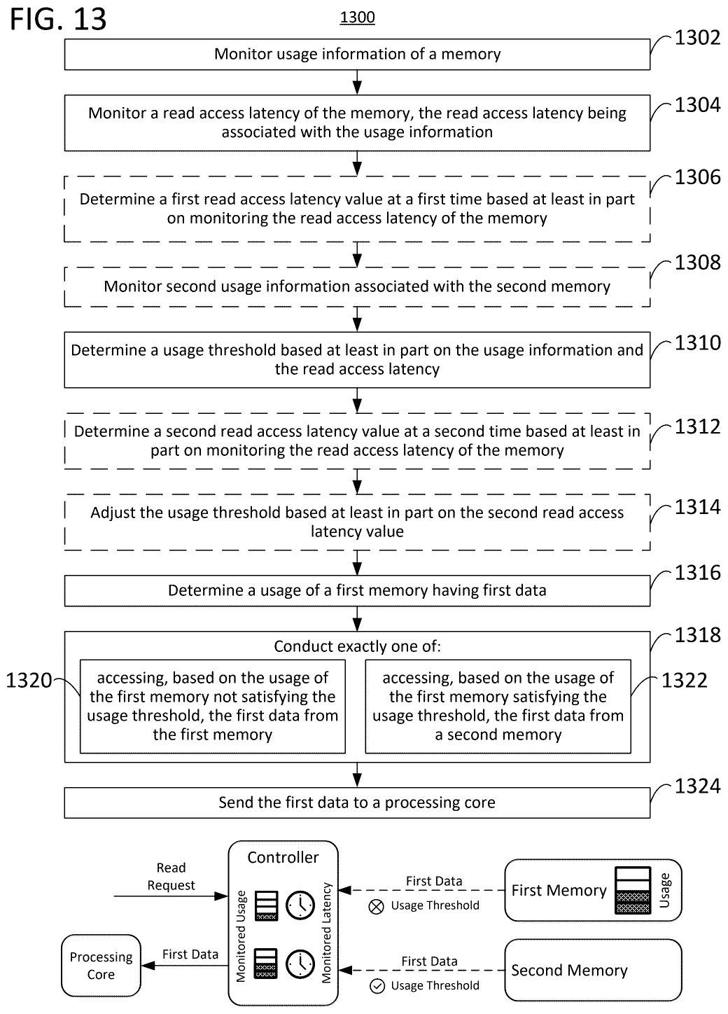

FIG. 13 illustrates an example of method 1300 for determining a usage threshold and routing a request to memory based on the usage threshold. Method 1300 may be performed by a system including one or more processors and one or more memories (e.g., DDR memory and HBM memory). In specific embodiments, the system may include one or more memory controllers and one or more non-transitory computer-readable media. In various specific embodiments, steps of method 1300 may be duplicated, omitted, rearranged, or otherwise deviate from the form depicted in FIG. 13. Method 1300 may incorporate aspects of methods 1000, 1100, and/or 1200.

At step 1302, usage information of a memory may be monitored. In specific embodiments, the usage information may be associated with the first memory.

At step 1304, a read access latency of the memory may be monitored. The read access latency may be associated with the usage information (e.g., monitored at step 1302).

In specific embodiments, at step 1306, a first read access latency value may be determined. The first read access latency value may be determined at a first time and may be based on monitoring the read access latency of the memory (e.g., at step 1304). The usage threshold may be based on the first read access latency value.

In specific embodiments, at step 1308, second usage information may be monitored. The second usage information may be associated with the second memory and the usage information (e.g., of step 1302) may be associated with the first memory. The usage threshold may be based on the second usage information. In specific embodiments, the usage of the first memory satisfying or not satisfying the usage threshold may be based on a difference between the usage information and the second usage information.

At step 1310, a usage threshold may be determined. The usage threshold may be based on the usage information (e.g., monitored at step 1302) and the read access latency (e.g., monitored at step 1304). In specific embodiments, the usage threshold may be based on an increase of the read access latency from a low value within a latency range to a high value within a latency range. In specific embodiments, the usage threshold may be pre-programmed. In specific embodiments, the usage threshold may be based on a hysteresis of the memory.

In specific embodiments, at step 1312, a second read access latency value may be determined. The second read access latency value may be determined at a second time (e.g., different than the first time of step 1306) and may be based on monitoring the read access latency of the memory.

In specific embodiments, at step 1314, the usage threshold may be adjusted. The usage threshold may be adjusted based on the second read access latency value (e.g., determined at step 1312).

At step 1316, a usage of a first memory having a first data may be determined.

As part of step 1318, exactly one of either step 1320 or step 1322 may be performed. Performing either step 1320 or step 1322 may be based on the usage of the first memory satisfying or not satisfying the usage threshold. In specific embodiments, the usage of the first memory satisfying or not satisfying the usage threshold may be based on a difference between the usage information (e.g., of step 1302) and the second usage information (e.g., of step 1308).

At step 1320, the first data may be accessed from the first memory. The first data may be accessed from the first memory based on the usage of the first memory not satisfying the usage threshold. In specific embodiments, not satisfying the usage threshold is based on the usage of the first memory being below the usage threshold.

Alternatively to step 1320, at step 1322, the first data may be accessed from a second memory. The first data may be accessed from the second memory based on the usage of the first memory satisfying the usage threshold. In specific embodiments, satisfying the usage threshold is based on the usage of the first memory being above the usage threshold.

At step 1324, the first data may be sent to a processing core. Routing access requests as described by method 1300 may result in reduced latency for the requests.

At least one processor in accordance with this disclosure can include at least one non-transitory computer readable media. The at least one processor could comprise at least one computational node in a network of computational nodes. The media could include cache memories on the processor. The media can also include shared memories that are not associated with a unique computational node. The media could be a shared memory, could be a shared random-access memory, and could be, for example, a DDR DRAM. The shared memory can be accessed by multiple channels. The non-transitory computer readable media can store data required for the execution of any of the methods disclosed herein, the instruction data disclosed herein, and/or the operand data disclosed herein. The computer readable media can also store instructions which, when executed by the system, cause the system to execute the methods disclosed herein. The concept of executing instructions is used herein to describe the operation of a device conducting any logic or data movement operation, even if the “instructions” are specified entirely in hardware (e.g., an AND gate executes an “and” instruction). The term is not meant to impute the ability to be programmable to a device.

While the specification has been described in detail with respect to specific embodiments of the invention, it will be appreciated that those skilled in the art, upon attaining an understanding of the foregoing, may readily conceive of alterations to, variations of, and equivalents to these embodiments. Any of the method steps discussed above can be conducted by a processor operating with a computer-readable non-transitory medium storing instructions for those method steps. The computer-readable medium may be memory within a personal user device or a network accessible memory. Although examples in the disclosure were generally directed to heterogeneous memory with HBM memory acting as a cache to DDR memory, the same approaches could be utilized to reduce latency in other memory systems. These and other modifications and variations to the present invention may be practiced by those skilled in the art, without departing from the scope of the present invention, which is more particularly set forth in the appended claims.

What is claimed is:

1. A method for routing requests to memory comprising:
receiving, at a memory controller, a read request for first data;
determining, by the memory controller, a usage of a first memory having the first data;
conducting exactly one of: (i) accessing, by the memory controller based on the usage of the first memory satisfying a latency criteria, the first data from the first memory; (ii) accessing, by the memory controller based on the usage of the first memory not satisfying the latency criteria, the first data from a second memory, wherein the second memory is a cache for the first memory; and
sending, from the memory controller, the first data to a processing core.

2. The method of claim 1, wherein the first memory comprises a double data rate (“DDR”) memory, further comprising:
requesting, by the memory controller, the usage of the first memory from a first memory module of the first memory; and
providing, by the first memory module, the usage of the first memory to the memory controller.

3. The method of claim 2, wherein a first access latency of the first memory is less than a second access latency of the second memory when the latency criteria is satisfied.

4. The method of claim 3, wherein the first access latency of the first memory is greater than the second access latency of the second memory at least some of a time when the latency criteria is not satisfied.

5. The method of claim 3, wherein the second memory comprises high bandwidth memory (“HBM”) memory and wherein a second memory module interfaces between the memory controller and the second memory to provide the first data to the memory controller.

6. The method of claim 1, wherein the read request is provided to the memory controller based on one or more lower level caches not having the first data.

7. The method of claim 6, wherein the one or more lower level caches comprise a level one cache, a level two cache, and a level three cache.

8. The method of claim 6, wherein a first access latency of the one or more lower level caches is at least about an order of magnitude less than a second access latency of the first memory and a third access latency of the second memory.

9. The method of claim 1, wherein the usage of the first memory comprises a transient memory bandwidth utilization of the first memory.

10. The method of claim 9, wherein the latency criteria comprises a percentage usage of the first memory being less than a threshold percentage.

11. The method of claim 10, wherein the threshold percentage is based on an increase in access latency when the usage of the first memory exceeds the threshold percentage.

12. The method of claim 1, further comprising:
monitoring, for each of a plurality of usage values for the first memory, a respective access latency value.

13. The method of claim 12, wherein the latency criteria is based on the monitored usage values and respective access latency values.

14. The method of claim 13, further comprising:
dynamically modifying the latency criteria based on the monitored usage values and the respective access latency values.

15. The method of claim 1, further comprising:
determining, by the memory controller, whether the first data is in the second memory; and
accessing, by the memory controller, the first data from the first memory if the first data is not in the second memory, even if the latency criteria is not satisfied.

16. The method of claim 1, further comprising:
determining, by the memory controller, whether a data line of the second memory is clean; and
accessing, by the memory controller, the first data from the second memory if the data line is not clean, even if the latency criteria is satisfied.

17. One or more non-transitory computer-readable media storing instructions, which when executed by one or more processors cause the one or more processors to conduct a method for routing requests to memory, the method comprising:
receiving, at a memory controller, a read request for first data;
determining, by the memory controller, a usage of a first memory having the first data;
conducting exactly one of: (i) accessing, by the memory controller based on the usage of the first memory satisfying a latency criteria, the first data from the first memory; (ii) accessing, by the memory controller based on the usage of the first memory not satisfying the latency criteria, the first data from a second memory, wherein the second memory is a cache for the first memory; and
sending, from the memory controller, the first data to a processing core.

18. A method comprising:
monitoring usage information of a memory;
monitoring a read access latency of the memory, the read access latency being associated with the usage information;
determining a usage threshold based at least in part on the usage information and the read access latency;
determining a usage of a first memory having first data;
conducting exactly one of: (i) accessing, based on the usage of the first memory not satisfying the usage threshold, the first data from the first memory; (ii) accessing, based on the usage of the first memory satisfying the usage threshold, the first data from a second memory; and
sending the first data to a processing core.

19. The method of claim 18, wherein:
satisfying the usage threshold is based at least in part on the usage of the first memory being above the usage threshold; and
not satisfying the usage threshold is based at least in part on the usage of the first memory being below the usage threshold.

20. The method of claim 18, wherein:
the usage threshold is based at least in part on an increase of the read access latency from a low value within a latency range to a high value within the latency range.

21. The method of claim 18, further comprising:
determining a first read access latency value at a first time based at least in part on monitoring the read access latency of the memory, wherein the usage threshold is based at least in part on the first read access latency value;
determining a second read access latency value at a second time based at least in part on monitoring the read access latency of the memory; and
adjusting the usage threshold based at least in part on the second read access latency value.

22. The method of claim 18, wherein:
The usage threshold is pre-programmed.

23. The method of claim 18, wherein:
The usage threshold is based at least in part on a hysteresis of the memory.

24. The method of claim 18, wherein the usage information is associated with the first memory and the method further comprises:
monitoring second usage information associated with the second memory, wherein the usage threshold is based at least in part on the second usage information.

25. The method of claim 24, wherein:
the usage of the first memory satisfying or not satisfying the usage threshold is based at least in part on a difference between the usage information and the second usage information.
